(19) United States
(12) Patent Application Publication
(10) Pub. No.: US 2026/0317473 A1
(43) Pub. Date: Oct. 15, 2026

(54) POLYURETHANE COMPOSITIONS

(71) Applicant: B4PLASTICS BV, Dilsen-Stokkem (BE)

(72) Inventors: Stefaan De WILDEMAN, Maasmechelen (BE); Kristien VAN TILBURG, Maastricht (NL)

(21) Appl. No.: 19/484,654

(22) PCT Filed: May 17, 2024
(86) PCT No.: PCT/EP2024/063700

§ 371 Date: Nov. 14, 2025

(30) Foreign Application Priority Data
May 17, 2023 (EP) 23173994.7

(51) Int. Cl. C08G 18/56; C08G 4/00; C08G 18/18; C08J 5/18

(52) U.S. Cl. CPC C08G 18/56; C08G 4/00; C08G 18/1816; C08J 5/18; C08G 2230/00

(57) ABSTRACT

The present invention relates to polyurethane compositions. Particularly, polyacetals and polyols that can be utilized to form a polyurethane and methods for preparation. The invention further relates to the use of polyurethane coatings for sustained, modified or delayed release for an active ingredient.

### FIELD OF THE INVENTION

The present invention relates to polyurethane compositions. Particularly, polyacetals and polyols that can be utilized to form a polyurethane and methods for preparation. The invention further relates to the use of polyurethane articles for sustained, modified or delayed release for an active ingredient.

### BACKGROUND

Polyurethanes are a valuable class of plastic materials that can be used in a variety of applications ranging from paints and varnishes to coatings and foams. Depending on the application of interest, polyurethanes with different mechanical properties are required. Generally, to obtain such a broad range of mechanical properties, the structure or composition of the key building blocks is changed. One way to introduce structural variety is to prepare different polyols such as polyether and polyester polyols. However, varying the structure or composition of a polyol may also result in undesirable properties such as decreased resilience and/or durability of the final polyurethane product. Accordingly, a need exists to prepare polyurethane formulations that are able to introduce novel properties without compromising their structural integrity.

### SUMMARY OF THE INVENTION

A first overview of various aspects of the technology of the present disclosure is given hereinbelow, after which specific embodiments will be described in more detail. This overview is meant to aid the reader in understanding the technological concepts more quickly, but it is not meant to identify the most important or essential features thereof, nor is it meant to limit the scope of the present disclosure, which is limited only by the claims.

A first aspect of the invention relates to a polyurethane formulation comprising:
a polyacetal having at least one cyclic acetal functional group and a number average molecular weight (Mₙ) of from 500 to 1500 g/mol;
optionally a polyol; and
an isocyanate;
preferably wherein the polyurethane formulation comprises between 1.0 and 55.0 mol % of polyacetal and between 45.0 and 99.0 mol % of isocyanate, preferably between 30.0 and 55.0 mol % of polyacetal and between 45.0 and 70.0 mol % of isocyanate.

In another aspect, the present invention relates to a polyurethane formulation comprising:
i) a polyacetal having at least four cyclic acetal functional groups and a number average molecular weight (Mₙ) of from 500 to 1500 g/mol;
ii) optionally a polyol; and
iii) an isocyanate;
   preferably wherein the polyurethane formulation comprises between 1.0 and 55.0 mol % of polyacetal and between 45.0 and 99.0 mol % of isocyanate, preferably between 30.0 and 55.0 mol % of polyacetal and between 45.0 and 70.0 mol % of isocyanate.

In particular, the polyurethane formulation as disclosed herein comprises between 1.0 and 15.0 mol % of polyacetal, between 25.0 and 54.0 mol % of polyol and between 31.0 and 74.0 mol % of isocyanate, preferably between 7.5 and 12.5 mol % of polyacetal, between 35.0 and 45.0 mol % of polyol and between 47.5 and 52.5 mol % of isocyanate.

In a particular embodiment, the polyurethane formulation as disclosed herein provides that the polyacetal further comprises at least one cyclic ketal functional group.

In a particular embodiment, the polyurethane formulation as disclosed herein provides that the polyacetal is a polymer or oligomer resulting from the condensation of an aldehyde or ketone monomer and an alcohol; and preferably wherein the aldehyde or ketone monomer is selected from the group consisting of: glyoxal, methyl-glyoxal, malonic dialdehyde, succinic dialdehyde, glutaraldehyde, 2,3-pentanedione, 2,4-pentanedione, 2,3-hexanedione, 2,4-hexanedione, 2,5-hexanedione, 3,4-hexanedione, 2-methyl malonic dialdehyde, 2-methyl succinic dialdehyde, 2,3-dimethyl succinic dialdehyde, 2,3-cyclopentanedione, 1,3-cyclopentanedione, 2-methyl-1,3-cyclopentanedione, 1,2-cyclohexanedione, 1,3-cyclohexanedione, 1,4-cyclohexanedione, 2-methyl-1,4-cyclohexanedione, phthalaldehyde, isophthalaldehyde, terephthalaldehyde, homophthalaldehyde, 1-phenyl-1,2-propanedione, digoxin, glucosone, 3-deoxyglucosone, 4-deoxyglucodiulose, 1,4-dideoxyglucodiulose, dihydroxyacetone, glyceraldehyde, threose, erythrose, lyxose, xylose, arabinose, ribose, talose, idose, galactose, sorbose, gulose, glucose, mannose, allose, altrose, sedoheptulose, and mixtures thereof. Preferably, the alcohol is a monomer selected from the group consisting of: glucosone, 3-deoxyglucosone, 4-deoxyglucodiulose, 1,4-dideoxyglucodiulose, dihydroxyacetone, glyceraldehyde, threose, erythrose, lyxose, xylose, arabinose, ribose, talose, idose, galactose, sorbose, gulose, glucose, mannose, allose, altrose, sedoheptulose, glycerol, D-threitol, pentaerythreitol, ribitol, sorbitol, trimethylolpropane, trimethylolbutane, trimethylolpentane, trimethylolhexane, and mixtures thereof.

In a particular embodiment, the polyurethane formulation as disclosed herein provides that the polyacetal has an OH-number of between 10-350 mg KOH/g.

In a particular embodiment, the polyurethane formulation as disclosed herein provides that the polyacetal has an OH-number of 150-350 mg KOH/g.

In a particular embodiment, the polyurethane formulation as disclosed herein provides that the polyacetal has a density of 1.15-1.35 10³ kg/m³.

In a particular embodiment, the polyurethane formulation as disclosed herein provides that the polyol comprises an aliphatic or aromatic polyester polyol, a polyether polyol, an acrylic polyol and/or a phenolic resin polyol.

In a particular embodiment, the polyurethane formulation as disclosed herein provides that the isocyanate comprises any one of hexamethylene diisocyanate (HDI), isophorone diisocyanate (IPDI), toluene diisocyanate (TDI) or methylene diphenyl diisocyanate (MDI), including any isomeric, oligomeric, monomeric, or polymeric forms thereof, preferably MDI, including any isomeric, oligomeric, monomeric, or polymeric forms thereof.

In a particular embodiment, the polyurethane formulation as disclosed herein further comprises a catalyst; and preferably wherein said catalyst is an amine, a metal, or a mixture thereof.

In another aspect, the present invention relates to a polyurethane article made from a polyurethane polymer obtained by curing any of the polyurethane formulations as disclosed herein.

In a particular embodiment, the polyurethane article as disclosed herein is selected from the group consisting of a film, a sheet, a laminate, and a foam.

In another aspect, the present invention relates to a method for preparing a polyurethane formulation as disclosed herein comprising the steps of mixing a polyacetal, a polyol and isocyanate and reacting these compounds to form a polyurethane composition. More in particular, the method comprises the steps of:
i) mixing a polyacetal, a polyol and isocyanate to obtain a curing mixture;
ii) optionally contacting the curing mixture with a gaseous catalyst;
iii) reacting the components of the preceding steps to form a polyurethane composition;
iv) drying said polyurethane composition at a temperature of at least 30° C. and at most 150° C., preferably at least 50° C. and at most 100° C.

The present invention relates in another aspect to the use of a polyurethane formulation as disclosed herein, as coating for providing the sustained, modified or delayed release for an active ingredient.

In a particular embodiment, the use of the polyurethane formulation as disclosed herein, is for rendering polymeric articles at least partially biodegradable via microbial incubation according to ASTMD5988-18 and/or EN13432.

### DETAILED DESCRIPTION

In the following detailed description, the technology underlying the present disclosure will be described by means of different aspects thereof. It will be readily understood that the aspects of the present disclosure, as generally described herein, can be arranged, substituted, combined, and designed in a wide variety of different configurations, all of which are explicitly contemplated and make part of this disclosure. This description is meant to aid the reader in understanding the technological concepts more easily, but it is not meant to limit the scope of the present disclosure, which is limited only by the claims.

As used herein, the singular forms “a”, “an”, and “the” include both singular and plural referents unless the context clearly dictates otherwise.

The terms “comprising”, “comprises” and “comprised of” as used herein are synonymous with “including”, “includes”, “containing”, or “contains”, and are inclusive or open-ended and do not exclude additional, non-recited members, elements or method steps. The terms also encompass “constituted of”, “consists in”, “consisting of”, and “consists of”, and also the terms “consisting essentially of”, “consisting essentially in” and “consists essentially of”, which enjoy well-established meanings in patent terminology.

The recitation of numerical ranges by endpoints includes all integer numbers and, where appropriate, fractions subsumed within the respective ranges, as well as the recited endpoints. This applies to numerical ranges irrespective of whether they are introduced by the expression “from . . . to . . . ” or the expression “between . . . and . . . ” or another expression. Any numerical range recited herein is intended to include all sub-ranges subsumed therein.

The terms “about” or “approximately” as used herein when referring to a measurable value such as a parameter, an amount, a temporal duration, and the like, are meant to encompass variations of and from the specified value, such as variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein. Whereas the terms “one or more” or “at least one”, such as one or more members or at least one member of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members. In another example, “one or more” or “at least one” may refer to 1, 2, 3, 4, 5, 6, 7 or more.

As used herein, the term “and/or” when used in a list of two or more items, means that any one of the listed items can be employed by itself or any combination of two or more of the listed items can be employed. For example, if a list is described as comprising group A, B, and/or C, the list can comprise A alone, B alone, C alone, A and B in combination, A and C in combination, B and C in combination, or A, B, and C in combination.

As used throughout the present disclosure, the terms “wt %” or “weight %” or “% w/w” or “% by weight” are used interchangeably and refer to the weight concentration of a constituent, i.e. the weight of a constituent divided by the total weight of all constituents.

The discussion of the background to the invention herein is included to explain the context of the invention. This is not to be taken as an admission that any of the material referred to was published, known, or part of the common general knowledge in any country as of the priority date of any of the claims.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the invention. When specific terms are defined in connection with a particular aspect of the invention or a particular embodiment of the invention, such connotation or meaning is meant to apply throughout this specification, i.e., also in the context of other aspects or embodiments of the invention, unless otherwise defined.

In the following passages, different aspects or embodiments of the invention are defined in more detail. Each aspect or embodiment so defined may be combined with any other aspect(s) or embodiment(s) unless clearly indicated to the contrary. In particular, any feature indicated as being preferred or advantageous may be combined with any other feature or features indicated as being preferred or advantageous.

Reference throughout this specification to “one embodiment”, “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Similarly, it should be appreciated that in the description of illustrative embodiments of the invention, various features of the invention are sometimes grouped together in a single embodiment, figure, or description thereof for the purpose of streamlining the disclosure and aiding in the understanding of one or more of the various inventive aspects.

In one or more aspects, the present invention relates to polyurethane compositions; in particular comprising polyacetal, isocyanate and optionally polyol. Given the large amount of waste generated by plastic products, one interesting feature for polyurethanes would be to improve their susceptibility to (microbial or other) degradation when exposed to natural environments. The rate of degradation is typically dependent on parameters such as temperature, time, and humidity, but will also depend heavily on the microstructure of the corresponding plastic. The present invention therefore provides alternative and even improved polyurethane formulations, that provide inter alia improved degradability of the resulting polymeric materials. Moreover, it was surprisingly found by the inventors that the incorporation of polyacetals into polyurethane microstructure aids in improving their (bio)degradation rate. One desirable attribute of the degradable polyurethane compositions discussed herein is that they may result in more ecologically-friendly polyurethane polymers and articles that degrade in a more controlled manner as compared to conventional polyurethanes.

As corroborated by the experimental section, which illustrates certain representative embodiments of the present invention, the inventors have demonstrated that the polyurethane formulations of the present invention provide polymers and articles that are compostable and/or chemically recyclable without a loss of structural integrity.

As used throughout the present disclosure, the terms “polymeric materials” or “polymer material” or “material” or “polymer article” are used interchangeably and refer to organic materials consisting of multiple repeating subunits or monomers, typically created via a polymerization process. Polymeric materials are further optimized to become functional plastic materials by so-called compounding steps: often a customized set of additives and fillers is combined with specific processing conditions to result in a functional plastic article. Additives can be colorants, chemical stabilizers such as antioxidants, process stabilizing agents, nucleating agents or lubricants. Fillers can typically be inorganic salts or (micro) crystalline materials. Processing steps generally rely on extrusion equipment, injection moulding, or additive manufacturing methods. Resulting functionalities are optimized towards the specific application; i.e. towards wishes, norms and values in the market environment.

The term “(bio)degradation” as used herein refers to the process of (biologically) disintegrating materials by microorganisms, such as bacteria, fungi, or other biological means into biomass and/or biogas. When the material is completely degraded, mineral components are released into the environment such as carbon dioxide, methane, water, sulfide, sulfate, ammonia, nitrite, nitrate, phosphate, and phosphite. Accordingly, a “(bio)degradable material” is a material that can be (biologically) disintegrated and mineralized by microorganisms in a period of time, such as hours, days or weeks. The (bio)degradability of a material may be primarily determined by the presence of specific enzymes produced by the present microbial community that are capable of endo- or exo-cleaving of the polymeric backbones in the respective polymeric material, liberating metabolizable carbon for building biomass and/or biogas. The biodegradability of a material can thereby be affected by a number of secondary factors that optimize the degradative capabilities by the present microbial community, such as temperature, pH, nutrients, water and oxygen. Additionally, auxiliary factors may also influence the biodegradation, which can be intrinsic to the material itself such as crystallinity, surface roughness and bioavailability of polymeric chains or their released fragments, or be dependent on environmental conditions impacting the nature of the material such as light intensity and mechanical wear, such as (oceanic) waving or shaking. In some embodiments the degradability is related to the degradability of a polymeric material in an aqueous (marine) environment.

For the purposes of the present invention, a polyurethane polymer or article is considered compostable or biodegradable when a defined fraction is removed by mineralization to carbon dioxide, water, and optionally cell mass growth, within a defined timeframe under a defined set of (environmental) conditions. A polyurethane polymer or article is considered chemically recyclable when at least part of the monomers can be recycled or collected after exposure to a defined set of (environmental) conditions under a defined timeframe.

In a first aspect the present invention relates to a polyurethane formulation comprising:
i) a polyacetal having at least one cyclic acetal functional group and a number average molecular weight (Mₙ) of from 500 to 1500 g/mol;
ii) optionally a polyol; and
iii) an isocyanate;
preferably wherein the polyurethane formulation comprises between 1.0 and 55.0 mol % of polyacetal and between 45.0 and 99.0 mol % of isocyanate, between 10.0 and 55.0 mol % of polyacetal and between 45.0 and 90.0 mol % of isocyanate, between 20.0 and 55.0 mol % of polyacetal and between 45.0 and 80.0 mol % of isocyanate, preferably between 30.0 and 55.0 mol % of polyacetal and between 45.0 and 70.0 mol % of isocyanate, preferably between 40.0 and 55.0 mol % of polyacetal and between 45.0 and 60.0 mol % of isocyanate, preferably between 45.0 and 55.0 mol % of polyacetal and between 45.0 and 55.0 mol % of isocyanate, preferably between 47.5 and 52.5 mol % of polyacetal and between 47.5 and 52.5 mol % of isocyanate.

The polyurethane polymer as defined herein has the important (end-of-life) advantage that, at least partially, said polymer is compostable (i.e. biodegradable) according to European norm EN13432, or is chemically recyclable. Without being bound by any theory, the polymers can thus be degraded biologically (i.e. composted) into carbon dioxide, water, and optionally cell mass growth or chemically recycled into their corresponding monomers. Hence, it has been found that it is possible to provide a polyurethane formulation that overcomes at least some of the drawbacks of the prior art. The polyurethane polymers comprising a polyacetal having at least one cyclic acetal functional group show excellent mechanical properties, despite being compostable and/or chemically recyclable.

In preferred embodiments, the polyurethane composition according to a first aspect of the invention may comprise a polyacetal having at least four cyclic acetal functional groups; such as four cyclic acetal functional groups, five cyclic acetal functional groups, six cyclic acetal functional groups, seven cyclic acetal functional groups, eight cyclic acetal functional groups, nine cyclic acetal functional groups, or ten cyclic acetal functional groups.

Soft segments in polyurethane materials typically comprise long-chain polyols, polyether polyols, or polyester polyols. Advantageously, extensive experimentation by the present inventors has revealed that the present polyurethane formulation comprising a polyacetal having at least four cyclic acetal functional groups may simultaneously introduce soft segments and provide the resulting polyurethane with improved biodegradability. This is in contrast to polyacetals comprising a lower amount of cyclic acetal functional groups, where the stiffness of a polyacetal chain needs to be compensated by the addition of flexible polyol chains in the resulting polyurethane polymer. Advantageously, the incorporation of soft segments is an important aspect of industrial polyurethane synthesis and may provide optimized mechanical properties, flexibility, and versatility, making them applicable in a diverse range of industries such as automotive, construction, medical, and textiles. In addition, the ability to fine-tune the balance between hard and soft segments is highly desirable and provides great flexibility and variability in material design. Preferably, said cyclic acetal functional groups are arranged consecutively within the backbone of the polyacetal. The present inventors have surprisingly found that having several cyclic acetal functional groups within the polymer backbone (i.e., main chain) of the polyacetal may have an important effect on the compostability and/or biodegradability of the polyurethane polymer or article obtained from the polyurethane formulation as disclosed herein. Without wishing to be bound by theory, it is rationalized that the polyurethane polymer or article obtained from the polyurethane formulation may organize in a non-random or ordered manner into one or more “blocks” (i.e., a portion of the macromolecule) comprising cyclic acetal units. This arrangement or grouping of specific monomeric units in the polymer chain may significantly improve the biodegradability of the polyurethane polymer or article without significantly decreasing the mechanical stability of said polyurethane polymer or article.

It should be noted that a polyacetal comprising cyclic acetal functional groups within a side chain (or branch) of the polyacetal may not, or to a much lesser extent, improve the compostability or biodegradability of the resulting polyurethane polymer or article.

In a particular embodiment, a polyurethane formulation as disclosed herein comprises between 0.5 and 20.0 mol % of polyacetal, between 15.0 and 60.0 mol % of polyol and between 20.0 and 84.5 mol % of isocyanate, preferably between 1.0 and 15.0 mol % of polyacetal, between 25.0 and 54.0 mol % of polyol and between 31.0 and 74.0 mol % of isocyanate, preferably between 5.0 and 15.0 mol % of polyacetal, between 30.0 and 54.0 mol % of polyol and between 31.0 and 65.0 mol % of isocyanate, preferably between 5.0 and 12.5 mol % of polyacetal, between 30.0 and 45.0 mol % of polyol and between 31.0 and 52.5 mol % of isocyanate, and most preferably between 7.5 and 12.5 mol % of polyacetal, between 35.0 and 45.0 mol % of polyol and between 47.5 and 52.5 mol % of isocyanate. Substituting part of the polyacetal in the polyurethane formulation for a polyol provides improved flexibility in terms of properties such as thermal and UV resistance, rigidity, and viscosity.

The polyacetal as used herein may refer to a prepolymer or oligomer containing two or more hydroxyl end-groups and cyclic acetal or ketal repeating units in the backbone. Typically, cyclic acetals or ketals are obtained through a reaction involving an aldehyde or ketone, respectively, and a diol or polyol, optionally in the presence of a catalyst. In the simplest case, cyclic acetals may be obtained from the condensation reaction of a carbonyl (i.e. aldehyde or ketone) with two hydroxyl groups. By removing the condensate, water, a cyclic acetal or ketal is formed. A commonly applied method to remove the water from the reaction is azeotropic distillation in a Dean-Stark apparatus. This reaction (and possible reverse reactions such as degradation) may further proceed through acid catalyzed equilibria and hemiacetal or hemiketal intermediate(s). Commonly a Brønsted acid may be used. Examples of suitable Brønsted acids include carboxylic acids and sulfonic acids. Suitable commercially available Brønsted acids include, for example, Dowex® 50WX8 from the DOW Chemical Company. A hemiacetal or hemiketal refers to the fact that only one of the two hydroxyl groups, for acetal or ketal formation, has been added to the carbonyl group. In certain embodiments, the polyacetal may be a semi-crystalline prepolymer or oligomer.

It should be understood that polyacetals comprising cyclic acetal repeating units, obtainable from the reaction of an aldehyde and a diol or polyol, are different from traditional polyacetals comprising linear acetal repeating units, obtainable from the reaction of an aldehyde and a monofunctional alcohol. In particular, it has been found that polyacetals comprising cyclic acetal repeating units may allow for a more controlled biodegradation and/or hydrolysis. Another advantage is that the polyacetals as described herein may have a lower viscosity when compared to polyacetals of the prior art (comprising linear acetal repeating units), which is advantageous during processing and handling of the polyurethane formulation as disclosed herein.

The current inventors have found that polyacetals comprising at least one cyclic acetal unit, preferably at least four cyclic acetal units, provide at the same time a more controlled susceptibility towards hydrolysis and biodegradation and improved thermal and mechanical properties.

The term “prepolymer” as used herein refers to a system of monomers that have been reacted to intermediate molecular mass or a polymer capable of entering into further polymerization or curing through its reactive groups. Reactive groups may be positioned at the chain-end or side chain. In the context of the present invention, a prepolymer or oligomer contains at least two functional groups capable of interacting with another reactive molecule. For instance, in some embodiments, the polyacetal as disclosed herein may be a prepolymer comprising at least two alcohol end-groups and at least four cyclic acetal functional groups in the prepolymer backbone. Preferably, the alcohol end-groups may react with electrophiles such as isocyanate to form a polyurethane polymer or article.

The “cyclic acetal” as used herein, such as a five and/or six membered cyclic acetal, may be obtained when combining an aldehyde and an alcohol (e.g., a diol or polyol).

A “cyclic ketal” as used herein, such as a five and/or six membered cyclic ketal, may be obtained when combining a ketone and an alcohol (e.g., a diol or polyol).

Preferably, the cyclic acetal may be obtained by means of condensation of a compound comprising one or more aldehyde functional group and a diol or polyol; or by means of self-condensation of a compound comprising one or more aldehyde functional group and one or more alcohol functional group. The term “self-condensation” is intended to refer to a AB-type of chemical reaction wherein a compound or molecule, comprising both aldehyde (or ketone) (A) and alcohol (B) functional groups, is capable of reacting with itself.

In particular embodiments, the polyacetal as disclosed herein may further comprise at least one cyclic ketal functional group to facilitate (bio)degradation of the polyurethane composition. Without wishing to be bound by theory, intermediates formed during hydrolysis of cyclic ketals are less stable than those of cyclic acetals and therefore were found to promote degradation.

In some embodiments, the polyacetal may be obtained by condensation of a compound comprising one or more aldehyde or ketone functional group, and one or more alcohol; and preferably wherein said compound may be selected from the group comprising: glyoxal, methyl-glyoxal, malonic dialdehyde, succinic dialdehyde, glutaraldehyde, 2,3-pentanedione, 2,4-pentanedione, 2,3-hexanedione, 2,4-hexanedione, 2,5-hexanedione, 3,4-hexanedione, 2-methyl malonic dialdehyde, 2-methyl succinic dialdehyde, 2,3-dimethyl succinic dialdehyde, 2,3-cyclopentanedione, 1,3-cyclopentanedione, 2-methyl-1,3-cyclopentanedione, 1,2-cyclohexanedione, 1,3-cyclohexanedione, 1,4-cyclohexanedione, 2-methyl-1,4-cyclohexanedione, phthalaldehyde, isophthalaldehyde, terephthalaldehyde, homophthalaldehyde, 1-phenyl-1,2-propanedione, digoxin, glucosone, 3-deoxyglucosone, 4-deoxyglucose, 1,4-dideoxyglucose, dihydroxyacetone, glyceraldehyde, threose, erythrose, lyxose, xylose, arabinose, ribose, talose, idose, galactose, sorbose, gulose, glucose, mannose, allose, altrose, sedoheptulose, or a combination thereof. It should be clear that the compounds listed-above, comprising one or more aldehyde or ketone functional group, may refer to carbohydrates that may be configured to form an open-chain structure.

In some embodiments, the polyacetal may be obtained by condensation of a compound comprising one or more aldehyde or ketone functional group and one or more alcohol; and preferably wherein said compound may be selected from the group comprising: glyoxal, methyl-glyoxal, malonic dialdehyde, succinic dialdehyde, glutaraldehyde, 2,3-pentanedione, 2,4-pentanedione, 2,3-hexanedione, 2,4-hexanedione, 2,5-hexanedione, 3,4-hexanedione, 2-methyl malonic dialdehyde, 2-methyl succinic dialdehyde, 2,3-dimethyl succinic dialdehyde, 2,3-cyclopentanedione, 1,3-cyclopentanedione, 2-methyl-1,3-cyclopentanedione, 1,2-cyclohexanedione, 1,3-cyclohexanedione, 1,4-cyclohexanedione, 2-methyl-1,4-cyclohexanedione, phthalaldehyde, isophthalaldehyde, terephthalaldehyde, homophthalaldehyde, 1-phenyl-1,2-propanedione, digoxin, glucosone, 3-deoxyglucosone, 4-deoxyglucose, 1,4-dideoxyglucose, dihydroxyacetone, glyceraldehyde, or a combination thereof.

Preferably, the compound comprising one or more aldehyde or ketone functional group may be selected from the group comprising: glyoxal, isophthalaldehyde, dihydroxyacetone, malonic dialdehyde, succinic dialdehyde, glutaraldehyde, 1,4-cyclohexanedione, 2,3-pentanedione, or a combination thereof.

In some embodiments, the compound comprising one or more aldehyde or ketone functional group comprises said one or more alcohol. This has the advantage that said compound may self-condensate to form the polyacetal as defined herein, without the need to add additional alcohol molecules.

Alternatively, and in some embodiments, the one or more alcohol is selected from the group comprising: glycerol, D-threitol, pentaerythreitol, ribitol, sorbitol, trimethylolpropane, trimethylolbutane, trimethylolpentane, trimethylolhexane, or a combination thereof. Preferably, the one or more alcohol is selected from the group comprising: glycerol, pentaerythreitol, trimethylolpropane, or a combination thereof.

In some embodiments, the polyacetal may have a number average molecular weight (Mₙ) of from 500 to 1500 g/mol, 750 to 1500 g/mol, 1000 to 1500 g/mol, 1250 to 1500 g/mol, 500 to 1250 g/mol, 500 to 1000 g/mol, or 750 to 1000 g/mol determined from the total average OH number according to equation (I) below.

$${M}_{n} = \frac{n \times 1000}{X} \qquad ( I )$$

wherein
n=the number of analyzed groups in the polyacetal;
X=total average OH number or hydroxyl value of the polyacetal (mmol/g).

Polyacetal prepolymers or oligomers within Mₙ range as discussed herein allow mixing and dissolving of the polyacetal with isocyanates, and optionally a polyol, for polyurethane formation. Shorter polyacetal prepolymers or oligomers provide control over properties such as crystallinity and rigidity, which allows to optimize the rate of polyurethane degradation. However, too short polyacetal prepolymers or oligomers may result in a higher viscosity which is disadvantageous for processing and handling of the polyurethane formulation. In addition, this may also impact the distribution and formation of hard and soft domains within the polyurethane polymer or article, which may have an important impact on mechanical and thermal properties.

In some embodiments, the polyacetal may have a density of from 1.15 to 1.35 10³ kg/m³ determined according to ISO 758:1976.

In some embodiments, the polyacetal may have a total average OH number of from 10 to 350 mg KOH/g, or from 20 to 350 mg KOH/g or from 30 to 350 mg KOH/g, or from 40 to 350 mg KOH/g, from 50 to 350 mg KOH/g, from 60 to 350 mg KOH/g, from 70 to 350 mg KOH/g, from 80 to 350 mg KOH/g, from 90 to 350 mg KOH/g, from 100 to 350 mg KOH/g, from 110 to 350 mg KOH/g, from 120 to 350 mg KOH/g, from 130 to 350 mg KOH/g, or from 140 to 350 mg KOH/g, or from 150 to 350 mg KOH/g, or from 160 to 350 mg KOH/g, or from 170 to 350 mg KOH/g, or from 180 to 350 mg KOH/g, or from 190 to 350 mg KOH/g, or from 200 to 350 mg KOH/g, or from 250 to 350 mg KOH/g, or from 150 to 250 mg KOH/g determined according to the ASTM D 4274 method (test method C). The number of reactive hydroxyl (OH) groups on the polyacetal impacts the quantity of urethane bonds that are connected to or surrounded by a cyclic acetal and/or cyclic ketal functional group, which affects the rate of (bio)degradation. In particular, a higher local concentration or density of cyclic acetal and/or cyclic ketal functional groups is preferred when biodegradation needs to be accelerated.

In some preferred embodiments, the polyacetal comprises a number of hydroxyl (—OH) groups per molecule larger than 2, such as 3, or 4, or 5, or 6.

The polyacetals as described herein are suitable hydroxy-containing monomers for the synthesis of polyurethane polymers. Typically, polyurethane curing involves a polyaddition reaction of polyols and isocyanates. In principle, any hydroxy-containing molecule may participate in polyurethane curing. Typical molar ranges of polyol:isocyanate may include 50.0 mol % polyol, 47.5 mol % polyol, 45.0 mol % polyol, 42.5 mol % polyol, or 40.0 mol % polyol; and 50.0 mol % isocyanate, 52.5 mol % isocyanate, 55.0 mol % isocyanate, 57.5 mol % isocyanate, or 60.0 mol % isocyanate. In a particular embodiment, part of the polyol composition is substituted with the polyacetal.

Synthesis of the polyacetal as defined herein may involve heating the corresponding aldehyde and/or ketone in the presence of an alcohol and preferably an acid to at least 80° C., at least 100° C., at least 120° C., at least 130° C., at least 140° C., at least 150° C., preferably at least 125° C.

The “polyol” as used herein refers to a prepolymer or oligomer containing two or more terminal hydroxyl groups. Depending on the desired mechanical properties of the polyurethane, polyols and isocyanates with different backbones may be used. Suitable polyols may encompass polyether polyol, polyester polyol, acrylic polyol and/or phenolic resin polyol.

In some embodiments, examples of suitable polyether polyol may include polyoxyethylene polyols or polyoxypropylene polyols. Polyoxyethylene polyol or polyoxypropylene polyol herein refers to polyols that are polymerized products of ethylene oxide or propylene oxide. Suitable commercially available polyoxypropylene polyols include, for example, VORANOL and SPECFLEX available from The Dow Chemical Company.

In some embodiments, examples of suitable polyester polyol may include reaction products of polycarboxylic acids or their anhydrides with polyhydric alcohols. The polycarboxylic acids or their anhydrides may be aliphatic, cycloaliphatic, aromatic and/or heterocyclic. Examples of suitable polycarboxylic acids include oxalic acid, malonic acid, succinic acid, glutaric acid, adipic acid, pimelic acid, suberic acid, azelaic acid, sebacic acid, maleic acid, fumaric acid, glutaconic acid, α-hydromuconic acid, β-hydromuconic acid, α-butyl-α-ethyl-glutaric acid, α,β-diethylsuccinic acid, isophthalic acid, terephthalic acid, hemimellitic acid, 1,4-cyclohexane-dicarboxylic acid, or mixtures thereof. Examples of suitable polyhydric alcohols include ethylene glycol; 1,3-propylene glycol; 1,2-propylene glycol; 1,4-butylene glycol; 1,3-butylene glycol; 1,2-butylene glycol; 1,5-pentane diol; 1,4-pentane diol; 1,3-pentane diol; 1,6-hexane diol; 1,8-octane diol; neopentyl glycol; cyclohexane dimethanol; 1,7-heptane diol; glycerol; 1,1,1-trimethylolpropane; 1,1,1-trimethylolethane; hexane-1,2,6-triol; α-methyl glucoside; pentaerythritol; quinitol; mannitol; sorbitol; sucrose; methyl glycoside; diethylene glycol; triethylene glycol; tetraethylene glycol; dipropylene glycol; dibutylene glycol; or mixtures thereof.

In some embodiments, examples of suitable acrylic polyol may include the radical polymerization product of acrylic monomers, such as acrylic or methacrylic acids and esters with hydroxyalkyl acrylates or hydroxyalkyl methacrylates as comonomers. Examples of suitable phenolic resin polyol may include the reaction product of a phenol, an aldehyde and an aliphatic hydroxy compound containing two or more hydroxy groups.

Suitable isocyanates may encompass any one of hexamethylene diisocyanate (HDI), isophorone diisocyanate (IPDI), toluene diisocyanate (TDI) or methylene diphenyl diisocyanate (MDI), including any isomeric, oligomeric, monomeric, or polymeric forms thereof, preferably MDI, including any isomeric, oligomeric, monomeric, or polymeric forms thereof. Isocyanate condensation products can also be used. Isocyanates having isocyanurate, biuret, iminooxadiazine, and/or uretidione structural units are suitable. Some examples include DESMODUR from Bayer Corporation.

In particular, polyurethane curing as disclosed herein may further comprise the addition of a catalyst. In some preferred embodiments, the catalyst may comprise a metal, an amine, or a mixture thereof. The metal may be any metal known in the polyurethane art to catalyze polyurethane formation such as organotin catalysts. Examples of suitable organotin catalysts include stannous octoate, stannous oleate, stannic chloride, dimethyltin dilaurate and dibutyltin dilaurate. The amine may be any amine known in the polyurethane art to catalyze polyurethane formation such as tertiary amines, including alicyclic tertiary amines and aliphatic tertiary amines. Examples of suitable amine catalysts include aliphatic, alicyclic or heterocyclic tertiary amine catalysts such as N,N-dimethylcyclohexylamine, N,N,N′,N′-tetramethyl hexamethylene diamine and N,N′-dimethyl-N,N′-diisopropyl hexamethylenediamine, triethylenediamine, N-ethyl or methyl morpholine, N,N-dimethylaminoethyl morpholine, N-butylmorpholine, N,N′-dimethylpiperazine, bis-(dimethylamino-alkyl)-piperazine, and 1,2-dimethylimidazole. Organotin catalysts are generally used in conjunction with one or more tertiary amine catalysts.

When present, the concentration of the additional catalyst may be, based on the total number of moles of the polyacetal and polyol composition, 0.1 mol % or more, 1.0 mol % or more, or even 1.5 mol % or more.

Polyurethane curing may further comprise the addition of a blowing agent to form a foam-forming formulation. Preferably, the blowing agent is water. The concentration of water may be, based on the total number of moles of the polyacetal and polyol composition, 1 mol % or more, 2 mol % or more, 2.5 mol % or more, or even 3 mol % or more.

The formulation of the present invention may further comprise any one or combination of the following additives: pigments and colorants, flame retardants, antioxidants, surface modifiers, bioretardant agents, odor masks, antioxidants, ultraviolet (UV) stabilizers, antistatic agents and viscosity modifiers.

In some embodiments, curing of the polyurethane occurs in at least 0.1 min and at most 60.0 min, at least 0.5 min and at most 60.0 min, in at least 1.0 min and at most 60.0 min, in at least 1.0 min and at most 40.0 min, in at least 1.0 min and at most 20.0 min, in at least 1.0 min and at most 10.0 min, in at least 0.5 min and at most 10.0 min, in at least 0.1 min and at most 10.0 min; preferably in at least 0.5 min and at most 3.0 min. In some embodiments, curing of the polyurethane is performed in a convection oven with a pre-set temperature between at least 30° C. and at most 150° C., between at least 50° C. and at most 150° C., between at least 50° C. and at most 125° C., preferably between at least 50° C. and at most 100° C.

The rate of biodegradation as discloses herein may depend on the pH of the environment. In some embodiments, (bio)degradation occurs at a pH of at least 2 and at most 7, preferably at least 3 and at most 6.

In another aspect of the invention, a method is provided for preparing a polyurethane formulation that comprises:
i) mixing a polyacetal, optionally a polyol, and isocyanate to obtain a curing mixture;
ii) optionally contacting the curing mixture with a gaseous catalyst;
iii) reacting the components of the preceding steps to form a polyurethane composition;
iv) drying said polyurethane composition at a temperature of at least 30° C. and at most 150° C., preferably at least 50° C. and at most 100° C.

The term “curing mixture” as used herein refers to a collection of monomers, oligomers, and/or polymers that are able to react to produce a toughened or hardened polymeric material. In some embodiments, the obtained polymeric material may be amorphous and in a glassy or rubbery state. In some embodiments, the obtained polymeric material may be semi-crystalline. Drying of the polyurethane composition as disclosed herein may involve the use of a convection oven, vacuum oven, dessicator or similar equipment known to a skilled person.

The polyurethane polymer as obtained herein may comprise the reaction product of the polyacetal, optionally polyol, and isocyanate composition described above and may be processed into a polyurethane article. In certain embodiments, a polyurethane article made from the polyurethane formulation as described herein may include but is not limited to a film, a sheet, a laminate, or a foam. Such film, sheet or laminate may comprise a defined thickness and be oriented or non-oriented, and may for instance be a cast film, an uniaxially oriented film or biaxially oriented film. Non-limiting examples of polyurethane articles may include for instance a bag, a shoe sole, a mattress, or a protective film. In some embodiments, the laminate may include a top layer, an intermediate layer, and a substrate layer. At least one layer of the film may comprise a polyurethane, which provides at least some of the following properties: biodegradability, thermal stability, mechanical cushioning, insulation, sound dampening, color retention, and scratch resistance. Each layer of the laminate may further be transparent or reinforced with an inorganic filler. In some embodiments, the foam may be a flexible or a rigid foam.

In certain embodiments, the polyurethane article made from the polyurethane formulation as described herein may include but is not limited to a thermoformed article, an injection moulded article, an article made by injection stretch blow moulding, an article made by extrusion blow moulding, an article made by foaming, according to techniques well known to a skilled person. In certain embodiments, the processing of the polyurethane article involves the step of forming a multilayer structure.

In preferred embodiments, the polyurethane polymer obtained herein may be used as a coating for an active compound. The coating may provide a barrier layer to the active compound. When the polyurethane polymer is used as a coating, degradation may lead to a loss in barrier properties, exposing the coated active compound. If the coated active compound comprises an active ingredient, degradation of the coating may expose the active ingredient to the external environment. The coating may therefore provide the sustained, modified or delayed release for an active ingredient.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as follows in the spirit and scope of the appended claims.

The herein disclosed aspects and embodiments of the invention are further supported by the following non-limiting examples.

### EXAMPLES

### Example 1

In a round-bottom flask equipped with a stirring bar and a Dean-Stark distillation apparatus, 2.11 g of isophthalaldehyde and 3.26 g of pentaerythritol were mixed at 100 rpm in 100 ml of toluene in the presence of 50 mg Dowex® 50WX8 (i.e. a styrene divinylbenzene gel with sulfonic acid groups) and heated to 125° C. Water released from the top of the Dean-Stark distillation apparatus was condensed in a cold trap and kept separate from the reaction medium. Toluene was fed to the reaction to keep the overall volume of the reaction mixture above 50 mL. After 4 hours, the heated mixture was filtered, and excess of toluene was removed under reduced pressure in a rotavapor to obtain polyacetal A as a viscous liquid. The synthesis was repeated until a desired amount of polyacetal A was obtained.

The polyacetal A was subsequently used for the synthesis of a polyurethane. 10.0 g of isocyanate MDI and 10.1 g of polyacetal A were mixed in the presence of 0.2 g of dimethylcyclohexylamine catalyst, transferred to a silicon mould, and reacted at 80° C. during 15 minutes. A hard sheet was formed and collected from the silicon mould.

### Example 2

In a round-bottom flask equipped with a stirring bar and a Dean-Stark distillation apparatus, 3.60 g of dihydroxyacetone and 0.72 g of glycerol were mixed at 100 rpm in 100 mL of toluene in the presence of 50 mg Dowex® 50WX8 (i.e. a styrene divinylbenzene gel with sulfonic acid groups) and heated to 125° C. Water released from the Dean-Stark distillation apparatus was condensed in a cold trap and kept separate from the reaction medium. Toluene was fed to the reaction to keep the overall volume above 50 mL. After 4 hours, the heated mixture was filtered, and excess of toluene was removed under reduced pressure in a rotavapor to obtain polyacetal B as a viscous liquid. The synthesis was repeated until a desired amount of polyacetal B was obtained.

The polyacetal B was subsequently used for the synthesis of a polyurethane. 10.0 g of isocyanate MDI and 10.1 g of polyacetal B were mixed in the presence of 0.2 g of dimethylcyclohexylamine catalyst, transferred to a silicon mould, and reacted at 80° C. during 15 minutes. A hard sheet was formed and collected from the silicon mould.

### Example 3

In a round-bottom flask equipped with a stirring bar and a Dean-Stark distillation apparatus, 2.30 g of isophthalaldehyde and 3.11 g of pentaerythritol were mixed at 100 rpm in 100 ml of toluene in the presence of 50 mg Dowex® 50WX8 (i.e. a styrene divinylbenzene gel with sulfonic acid groups) and heated to 125° C. Water released from the top of the Dean-Stark distillation apparatus was condensed in a cold trap and kept separate from the reaction medium. Toluene was fed to the reaction to keep the overall volume of the reaction mixture above 50 mL. After 4 hours, the heated mixture was filtered, and excess of toluene was removed under reduced pressure in a rotavapor to obtain polyacetal C as a viscous liquid. The synthesis was repeated until a desired amount of polyacetal C was obtained.

The polyacetal C was subsequently used for the synthesis of a polyurethane. 10.0 g of isocyanate MDI and 10.1 g of polyacetal C were mixed in the presence of 0.2 g of dimethylcyclohexylamine catalyst, transferred to a silicon mould, and reacted at 80° C. during 15 minutes. A hard sheet was formed and collected from the silicon mould.

### Example 4

In a round-bottom flask equipped with a stirring bar and a Dean-Stark distillation apparatus, 2.11 g of isophthalaldehyde, 1.09 g of pentaerythritol and 1.47 g of glycerol were mixed at 100 rpm in 100 ml of toluene in the presence of 50 mg Dowex® 50WX8 (i.e. a styrene divinylbenzene gel with sulfonic acid groups) and heated to 125° C. Water released from the top of the Dean-Stark distillation apparatus was condensed in a cold trap and kept separate from the reaction medium. Toluene was fed to the reaction to keep the overall volume of the reaction mixture above 50 mL. After 4 hours, the heated mixture was filtered, and excess of toluene was removed under reduced pressure in a rotavapor to obtain polyacetal D as a viscous liquid. The synthesis was repeated until a desired amount of polyacetal D was obtained.

The polyacetal D was subsequently used for the synthesis of a polyurethane. 10.0 g of isocyanate MDI and 10.1 g of polyacetal D were mixed in the presence of 0.2 g of dimethylcyclohexylamine catalyst, transferred to a silicon mould, and reacted at 80° C. during 15 minutes. A hard sheet was formed and collected from the silicon mould.

### Example 5

In a round-bottom flask equipped with a stirring bar and a Dean-Stark distillation apparatus, 2.30 g of isophthalaldehyde, 1.04 g of pentaerythritol and 1.40 g of glycerol were mixed at 100 rpm in 100 ml of toluene in the presence of 50 mg Dowex® 50WX8 (i.e. a styrene divinylbenzene gel with sulfonic acid groups) and heated to 125° C. Water released from the top of the Dean-Stark distillation apparatus was condensed in a cold trap and kept separate from the reaction medium. Toluene was fed to the reaction to keep the overall volume of the reaction mixture above 50 mL. After 4 hours, the heated mixture was filtered, and excess of toluene was removed under reduced pressure in a rotavapor to obtain polyacetal E as a viscous liquid. The synthesis was repeated until a desired amount of polyacetal E was obtained.

The polyacetal E was subsequently used for the synthesis of a polyurethane. 10.0 g of isocyanate MDI and 10.1 g of polyacetal E were mixed in the presence of 0.2 g of dimethylcyclohexylamine catalyst, transferred to a silicon mould, and reacted at 80° C. during 15 minutes. A hard sheet was formed and collected from the silicon mould.

1-17. (canceled)

18. A polyurethane formulation comprising:
i) a polyacetal having at least four cyclic acetal functional groups and a number average molecular weight (Mₙ) of from 500 to 1500 g/mol;
ii) optionally a polyol; and
iii) an isocyanate;
wherein the polyacetal is a prepolymer comprising at least two alcohol end-groups; and preferably wherein the polyurethane formulation comprises between 1.0 and 55.0 mol % of polyacetal and between 45.0 and 99.0 mol % of isocyanate, preferably between 30.0 and 55.0 mol % of polyacetal and between 45.0 and 70.0 mol % of isocyanate.

19. A polyurethane formulation according to claim 18, wherein the polyurethane formulation comprises between 1.0 and 15.0 mol % of polyacetal, between 25.0 and 54.0 mol % of polyol and between 31.0 and 74.0 mol % of isocyanate, preferably between 7.5 and 12.5 mol % of polyacetal, between 35.0 and 45.0 mol % of polyol and between 47.5 and 52.5 mol % of isocyanate.

20. The polyurethane formulation according to claim 18, wherein the polyacetal further comprises at least one cyclic ketal functional group.

21. The polyurethane formulation according to claim 18, wherein the polyacetal is obtained by condensation of a compound comprising one or more aldehyde or ketone functional group and one or more alcohol; and preferably wherein said compound is selected from the group consisting of: glyoxal, methyl-glyoxal, malonic dialdehyde, succinic dialdehyde, glutaraldehyde, 2,3-pentanedione, 2,4-pentanedione, 2,3-hexanedione, 2,4-hexanedione, 2,5-hexanedione, 3,4-hexanedione, 2-methyl malonic dialdehyde, 2-methyl succinic dialdehyde, 2,3-dimethyl succinic dialdehyde, 2,3-cyclopentanedione, 1,3-cyclopentanedione, 2-methyl-1,3-cyclopentanedione, 1,2-cyclohexanedione, 1,3-cyclohexanedione, 1,4-cyclohexanedione, 2-methyl-1,4-cyclohexanedione, phthalaldehyde, isophthalaldehyde, terephthalaldehyde, homophthalaldehyde, 1-phenyl-1,2-propanedione, glucosone, 3-deoxyglucosone, 4-deoxyglucose, 1,4-dideoxyglucose, dihydroxyacetone, glyceraldehyde, threose, erythrose, lyxose, xylose, arabinose, ribose, talose, idose, galactose, sorbose, gulose, glucose, mannose, allose, altrose, sedoheptulose, and mixtures thereof.

22. The polyurethane formulation according to claim 21, wherein the compound comprises one or more aldehyde or ketone functional groups and further comprises one or more alcohol functional groups.

23. The polyurethane formulation according to claim 22, wherein the one or more alcohol functional groups is selected from: glycerol, D-threitol, pentaerythreitol, ribitol, sorbitol, trimethylolpropane, trimethylolbutane, trimethylolpentane, trimethylolhexane, and mixtures thereof.

24. The polyurethane formulation according to claim 18, wherein the polyacetal has an OH-number of between 10-350 mg KOH/g, preferably between 50-350 mg KOH/g, preferably between 100-350 mg KOH/g, preferably 150-350 mg KOH/g.

25. The polyurethane formulation according to claim 18, wherein the polyacetal has a density of between 1.15-1.35 10³ kg/m³.

26. The polyurethane formulation according to claim 18, wherein the polyol comprises an aliphatic or aromatic polyester polyol, a polyether polyol, an acrylic polyol and/or a phenolic resin polyol.

27. The polyurethane formulation according to claim 18, wherein the isocyanate comprises any one of hexamethylene diisocyanate (HDI), isophorone diisocyanate (IPDI), toluene diisocyanate (TDI) or methylene diphenyl diisocyanate (MDI), including any isomeric, oligomeric, monomeric, or polymeric forms thereof, preferably MDI, including any isomeric, oligomeric, monomeric, or polymeric forms thereof.

28. The polyurethane formulation according to claim 18, further comprising a catalyst; and preferably wherein said catalyst is an amine, a metal, or a mixture thereof.

29. A polyurethane article made from a polyurethane polymer obtained by curing the polyurethane formulation of claim 18.

30. The polyurethane article according to claim 29, wherein said polyurethane article is selected from a film, a sheet, a laminate, and a foam.

31. A method for preparing the polyurethane formulation of claim 18, comprising the steps of:
i) mixing a polyacetal, optionally a polyol, and isocyanate to obtain a curing mixture;
ii) optionally contacting the curing mixture with a gaseous catalyst;
iii) reacting components of step i) and ii) to form a polyurethane composition;
iv) drying said polyurethane composition at a temperature of at least 30° C. and at most 150° C., preferably at least 50° C. and at most 100° C.;
wherein the polyacetal is a prepolymer comprising at least two alcohol end-groups.

32. A method of providing sustained, modified, or delayed release of an active ingredient, comprising applying the polyurethane formulation according to claim 18 as a coating to the active ingredient.

33. A polymeric article coated with the polyurethane formulation according to claim 18, wherein the article is at least partially biodegradable via microbial incubation according to a test method selected from ASTM D5988-18 and/or EN 13432.
